(19) United States
(12) Patent Application Publication
(10) Pub. No.: US 2020/0110905 A1
(43) Pub. Date: Apr. 9, 2020

(54) SECURITY HARDENED SOFTWARE FOOTPRINT IN A COMPUTING ENVIRONMENT

(71) Applicant: CA, Inc., Islandia, NY (US)

(72) Inventor: Eoin O'Cleirigh, Praha (CZ)

(73) Assignee: CA, Inc., Islandia, NY (US)

(21) Appl. No.: 16/152,218

(22) Filed: Oct. 4, 2018

(51) Int. Cl. G06F 21/64; G06F 17/30; G06F 21/57

(52) U.S. Cl. CPC G06F 21/64; G06F 17/30097; G06F 2221/033; G06F 21/57; G06F 17/30371

(57) ABSTRACT

In an embodiment, a method includes performing a first validation procedure on an element that includes identifying a first hash value in a footprint of the element in a storage library, calculating a second hash value of the element in the storage library, and performing a first comparison of the first hash value and the second hash value. The first validation procedure further includes identifying, in a master file, a third hash value associated with the element in the storage library, performing a second comparison of the third hash value identified in the master file and one of the first hash value or the second hash value, and determining that the element is validated based on determining that the first validation comparison succeeds and that the second validation comparison succeeds.

### BACKGROUND

The present disclosure relates in general to the field of computer security, and more specifically, to a security hardened software footprint in a computing environment.

Secure and uncompromised production software is crucial to modern computer systems of enterprises and other entities. Software development systems often employ various techniques to ensure that software is not compromised at any point during the software development life cycle. The creation of executable code for a production library can involve numerous units, for example, source code, data templates, procedure code, uncompiled or untranslated code, non-production executable code, and production code. Ensuring the security and integrity of each module during the software development life cycle and continuously once an executable is running in a production environment can be difficult as malicious actors are constantly finding new ways to circumvent security measures.

### BRIEF SUMMARY

According to one aspect of the present disclosure, a first validation procedure can be performed on an element, which includes identifying a first hash value in a footprint of the element in a storage library, calculating a second hash value of the element in the storage library, performing a first comparison of the first hash value and the second hash value. The first validation procedure also includes identifying, in a master file, a third hash value associated with the element in the storage library, performing a second comparison of the third hash value identified in the master file and one of the first hash value or the second hash value, and determining that the element is validated based on determining that the first validation comparison succeeds and that the second validation comparison succeeds.

### BRIEF DESCRIPTION OF THE DRAWINGS

FIG. 1 is a simplified schematic diagram of an example computing environment in which security hardened software footprints are implemented according to at least one embodiment.

FIG. 2 is a simplified block diagram illustrating additional possible details of the computing environment with security hardened software footprints according to at least one embodiment.

FIG. 3 is a simplified block diagram illustrating further possible details of the computing environment with security hardened software footprints according to at least one embodiment.

FIG. 4 is a simplified block diagram illustrating possible details of a non-load library dataset according to at least one embodiment.

FIG. 5 is a simplified block diagram illustrating possible details of an executable library dataset according to at least one embodiment.

FIGS. 6A-6B show a simplified block diagram illustrating an example operation flow of the computing environment with security hardened software footprints according to at least one embodiment.

FIGS. 7A-7B are simplified flowcharts illustrating example techniques associated with generating security hardened footprints for software elements according to at least one embodiment.

FIGS. 8A-8B are simplified flowcharts illustrating further example techniques associated with generating security hardened footprints for software elements according to at least one embodiment.

FIGS. 9A-9B are simplified flowcharts illustrating further example techniques associated with generating security hardened footprints for software elements according to at least one embodiment.

FIGS. 10A-10B are simplified flowcharts illustrating example techniques associated with validation of security hardened footprints of software elements according to at least one embodiment.

FIG. 11 is a simplified flowchart illustrating further example techniques associated with real-time validation of security hardened footprints of software elements according to at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium include the following: a portable computer diskette, a hard disk, a random access memory (RAM), a read-only memory (ROM), a programmable read-only memory (PROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (RF), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, low-level programming languages such as assembly languages, conventional procedural programming languages, such as the “C” programming language, Visual Basic, Fortran 2003, Perl, COBOL 2002, PHP, ABAP, dynamic or script programming languages such as Python, Ruby and Groovy, batch file (.BAT or .CMD), powershell file, REXX, or any format of data that can describe sequences (e.g., XML, JSON, YAML, etc.), or other programming languages. By way of example, the program code may execute entirely on a local computer (e.g., server, server pool, desktop, laptop, appliance, etc.), partly on a mainframe system and partly on a local computer or remote computer (e.g., webserver), partly on the local computer and partly on a remote computer, entirely on a mainframe system, or entirely on a remote computer or server. In the scenarios involving a remote computer, the remote computer may be connected to a local computer or mainframe system through any type of network, including a local area network (LAN) or a wide area network (WAN), or the connection may be made to an external computer (for example, through the Internet using an Internet Service Provider) or in a cloud computing environment or offered as a service such as a Software as a Service (SaaS). Generally, any combination of one or more local computers and/or one or more remote computers may be utilized for executing the program code

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that, when executed, can direct a computer, other programmable data processing apparatus, or other devices to function in a particular manner, such that the instructions when stored in the computer readable medium produce an article of manufacture including instructions that, when executed, cause a computer to implement the function/act specified in the flowchart and/or block diagram block or blocks and/or the function/act specified in the interactions of the block diagrams. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks and/or functions/acts specified in the interactions of the block diagrams.

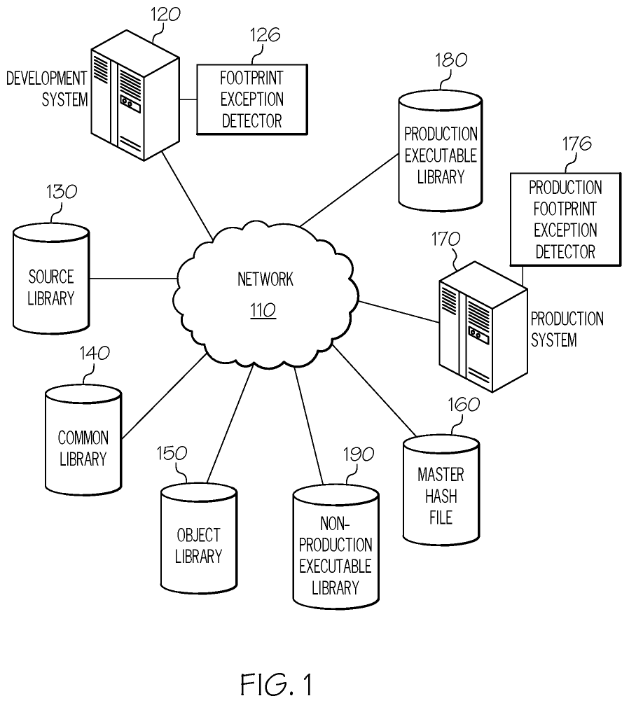

Referring now to FIG. 1, a simplified block diagram is shown illustrating an example computing environment 100 including a development system 120 and a production system 170, each of which may include web servers, application servers, database systems, mainframe systems, and/or other examples. Software components may be developed and/or tested using testing, quality assurance, and development tools hosted by one or more development systems (e.g., 120) and may be provided to a production system (e.g., 170) to be used for their intended purposes. Development system 120 may utilize data repositories (e.g., databases or other data structures) for storing software code in various stages of a software development cycle. In computing environment 100, example logical containers of a data repository are illustrated including a source library 130 for storing source code, a common library 140 for storing common code (e.g., copybook code) that can be included in multiple instances of source code, and an object library 150 for storing object code, and a non-production executable library 190 for storing executable code that is not in a production environment. Development system 120 may also include or have access to a master hash file 160, for storing hardened footprints of software code.

Production system 170 may utilize data repositories (e.g., databases or other data structures) for storing executable code to be executed for its intended purposes (e.g., services, mathematical calculations, web services, data gathering and management, manufacturing, etc.). In computing environment 100, an example logical container of another data repository is illustrated as production executable library 180 for storing executable code for execution by production system 170. Development system 120 and production system 170 may each include a footprint exception detector (e.g., 126, 176) for maintaining the security and integrity of footprints associated with software components in computing environment 100.

For purposes of illustrating certain example techniques of a computing environment (e.g., 100) that implements security hardened software footprints, it is important to understand the activities that may be occurring in the computing environment with a development system (e.g., 120) and a production system (e.g., 170). The following foundational information may be viewed as a basis from which the present disclosure may be properly explained.

Many businesses and other entities rely on software to conduct their business or other desired activities. These entities often rely on development systems (or third parties that use development systems) to create, develop, test, implement, maintain, and/or replace the software needed to achieve their purposes. Development systems are typically implemented in accordance with some form of a software or systems development life cycle in which certain tasks are performed at each stage in the software development process. Several (or all) of the stages can involve the generation or creation of some new form or arrangement of software code.

In at least one implementation of a development system (e.g., 120), an associated data repository, such as a database, may be provisioned with multiple logical containers for storing code associated with the different development stages. Examples of code that may be created or generated during the software development life cycle include, for example, source code, common code, object code, and executable code. Source code and common code are fundamental components of a computer program and may be written using a programming language, which is typically human-readable. While source code may be the functional foundation of a computer program, an instance of common code may contain code that is synchronized across multiple computer programs that each have a need for the same functionality provided by the common code. For example, one or more instances of source code may use appropriate instructions or commands in the relevant programming language to incorporate the desired common code. Object code is produced by compiling or assembling source code. Object code may contain binary code (also referred to as ‘machine code’) or an intermediate language (e.g., register transfer language (RTL)) representing a sequence of statements or instructions expressed in the source code. Object code may be non-executable and used to create executable code or, in some scenarios, object code may be executable. Executable code is software in a form that can be executed or run on a computer to perform tasks indicated by the encoded instructions. An executable code element (also referred to herein as ‘executable’ and ‘load module’) can be derived from object code by linking two or more elements of object code together.

In some systems, a data structure, such as a record or a collection of fields within a record, may be created for each element of executable code to enable verification that the executable is derived from a legitimate source. Such verification is desirable because any source code module for a particular entity could result in multiple outputs (e.g., load modules that are location-specific, customer-specific, subsidiary-specific, division-specific, service-specific, etc.) that are stored in different, and possibly remote, production systems. In one example, if multiple programs (or load modules) each need the same common code that provides a layout of a master file, then if the programs refer to different versions of the common code, the master file could be erroneously updated and/or the programs referring to an outdated version of the common code could process information from the master file based on erroneous assumptions due to the outdated master file layout. Accordingly, verifying that a load module was derived from the most current source code and common code is desirable and potentially critical for an entity's computing system to properly perform its intended activities or services.

A data structure used for this verification is referred to herein as ‘footprint.’ A footprint may be stored inside a load module and/or may also be stored in a directory structure associated with an element (e.g., executable code, source code, common code, object code). For example, in an example implementation involving a database with partitioned datasets, footprints can be stored in a directory structure of the dataset, which may store load modules (i.e., executable code elements), source code elements, common code elements or object code elements. For load modules with control sections (CSECTs), a respective footprint may also be stored inside each of the CSECTs.

A footprint may contain various metadata to identify the element for which it is generated and also to identify a source from which the element is derived (e.g., for load modules). For example, the footprint can include, but may not be limited to, environment information, system information, subsystem information, type information, and timeframe information such as version, level, and timestamp. In many scenarios, however, timestamps, are not sufficiently granular to distinguish footprints of different source code elements. A timestamp in minutes would not distinguish between two versions of a source code element that were generated within the same minute. Consequently, if footprints are used to verify that Program A contains legitimate source and common code, and if Program A calls common code B, common code C, and common code D, then no exception would be detected if, for example, one of the common code elements B, C, or D was changed or updated within the same minute.

Such footprints can be vulnerable to certain exploits depending on the type of files used to store the software code and footprints. In one example, standard utility tools may be capable of transforming an element (e.g., a library of dataset) into a flat file structure and subsequently restoring the flattened element to its original structure. A malicious user, however, could potentially use these utilities to flatten an element, modify the contents without modifying the footprint bits, and then restore the flattened element to its original structure. In this scenario, although the contents have been compromised, the footprint is unchanged and could be used to erroneously verify the element.

Current solutions to rectify this vulnerability are inadequate and inefficient. For example, a separate monitoring tool may be used to track and record accesses to privileged datasets, and to report such accesses. Such logs may rely on inefficient and potentially error-prone human monitoring to detect any suspect accesses. Moreover, such tools can only identify newly spoofed footprints, but not footprints that were previously compromised and that may continue to be in use after the introduction of the monitoring tool. Consequently, new techniques are needed to prevent spoofing footprints that are used in software development systems including, but not limited to mainframe release automation systems.

A computing environment that implements security hardened software footprints, such as computing environment 100 as outlined in the FIGURES, can resolve these issues and others. In the computing environment, a development system can provide new footprints for each element (e.g., source code, common code, object code, executable code). A footprint of a particular element includes a hash generated from the contents of that element upon the creation or update of that element. A master hash file can be maintained in connection with the footprints to store identifiers of the elements and their corresponding hashes. A hash of an element can be created or updated in the master file and in the footprint of the element in accordance with element creation, versioning, and changes, such as pre-compilation, compilation, assemblage, linkage, etc. of the elements. In addition, elements used to generate a lower-level element (e.g., source and common code elements used to generate object code elements, object code elements used to generate executable code elements) can be validated based on the hash in their footprint, prior to generating the lower-level element. The validation procedure for a particular element can include multiple validation checks. A first validation check can include calculating a hash of the contents of the element and comparing the calculated hash to the hash in the footprint of the element. A second validation check can include identifying a hash corresponding to the element in the master file and comparing the calculated hash or footprint hash to the identified hash in the master file. The element is validated if all of the validation checks are successful. Validation can be performed on at a regularly scheduled time, on-demand, or based on certain accesses (e.g., read, write, etc.) detected on an element.

Embodiments of computing environment 100, which implements security hardened software footprints, can offer several advantages. First, hashing the contents of an element and storing the hash in a footprint of the element and in a master file can ensure that attempts to modify the contents of the element without modifying the footprint (or hash) will not escape detection upon a check of the footprint hash and a hash that is calculated based on the current contents of the element and/or upon a check of the master file hash and the hash that is calculated based on the current contents of the element. Moreover, performing a three-way check of the footprint hash, the master file hash, and a hash of the current contents of the element provides enhanced security and can prevent malicious and inadvertent changes to the contents of any of the elements involved in software development.

Turning to FIG. 1, a brief description of the infrastructure of computing environment 100 is now provided. Components of FIG. 1 may be coupled to one another through one or more interfaces employing any suitable connections (wired or wireless), which provide viable pathways for network communications. Additionally, any one or more of these components of FIG. 1 may be combined or removed from the architecture based on particular configuration needs. Generally, computing environment 100 can be implemented in any type or topology of networks. Within the context of the disclosure, network 110 represents a series of points or nodes of interconnected communication paths for receiving and transmitting packets of information that propagate through computing environment 100. These networks offer communicative interfaces between sources, destinations, and intermediate nodes, and may include any local area network (LAN), virtual local area network (VLAN), wide area network (WAN) such as the Internet, wireless local area network (WLAN), metropolitan area network (MAN), Intranet, Extranet, virtual private network (VPN), and/or any other appropriate architecture or system that facilitates communications in a network environment or any suitable combination thereof. Network 110 can use any suitable technologies for communication including wireless (e.g., 3G/4G/5G/nG network, WiFi, Institute of Electrical and Electronics Engineers (IEEE) Std 802.11-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth, NFC, etc.).

In general, “servers,” “clients,” “computing devices,” “computing systems,” “data repositories,” “user devices,” “user terminals,” “systems,” “libraries,” “datasets,” etc. (e.g., 120, 130, 140, 150, 160, 170, 180, 190, etc.) in example computing environment 100, can include electronic computing devices operable to receive, transmit, process, store, or manage data and information associated with computing environment 100. As used in this document, the term “computer,” “processor,” or “processor device,” is intended to encompass any suitable processing device. For example, components shown as single devices within computing environment 100 may be implemented using a plurality of computing devices and processors, such as server pools including multiple server computers. In some embodiments, one or more of the components shown in FIG. 1 (e.g., 120, 130, 140, 150, 160, 170, 180, 190) may be combined in a mainframe system. Further, any, all, or some of the computing devices may be adapted to execute any operating system, including IBM zOS, Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, computing devices, computing systems, data repositories, user devices, user terminals, systems, libraries, datasets, etc. (e.g., 120, 130, 140, 150, 160, 170, 180, 190, etc.) can each include one or more processors, computer-readable memory, and one or more interfaces, among other features and hardware. Servers can include any suitable software component, manager, controller, or module, or computing device(s) capable of hosting and/or serving software applications and/or services, including distributed, enterprise, or cloud-based software applications, data, and services. For instance, in some implementations, development system 120, production system 170, data repositories (e.g., libraries 130, 140, 150, 160, 180, 190 and master hash file 160), or other sub-system of computing environment 100, can be at least partially (or wholly) cloud-implemented, web-based, or distributed to remotely host, serve, or otherwise manage data, software services and applications interfacing, coordinating with, dependent on, or used by other services, devices, and users (e.g., via network user terminals, other user terminals, etc.) in computing environment 100. In some instances, a server, system, subsystem, computing device, data repository etc. (e.g., 120, 130, 140, 150, 160, 170, 180, 190) can be implemented as some combination of devices that can be hosted on a common mainframe system, server, server pool, or cloud computing environment and share computing resources, including shared memory, processors, and interfaces.

While FIG. 1 is described as containing or being associated with a plurality of components, not all components illustrated within computing environment 100 of FIG. 1 may be utilized in each alternative implementation of the present disclosure. Additionally, one or more of the components described in connection with the examples of FIG. 1 may be located external to computing environment 100, while in other instances, certain components may be included within or as a portion of one or more of the other described components, as well as other components not described in the illustrated implementation. Further, one or more components illustrated in FIG. 1 may be combined with other components, as well as used for alternative or additional purposes in addition to those purposes described herein. By way of example, one possible implementation may include development system 120, source library 130, common library 140, object library 150, non-production executable library 190, and master hash file 160 being integrated within a mainframe system, while production system 170 and production executable library 180 are implemented remotely (physically or logically) in appropriate server(s) or another mainframe system.

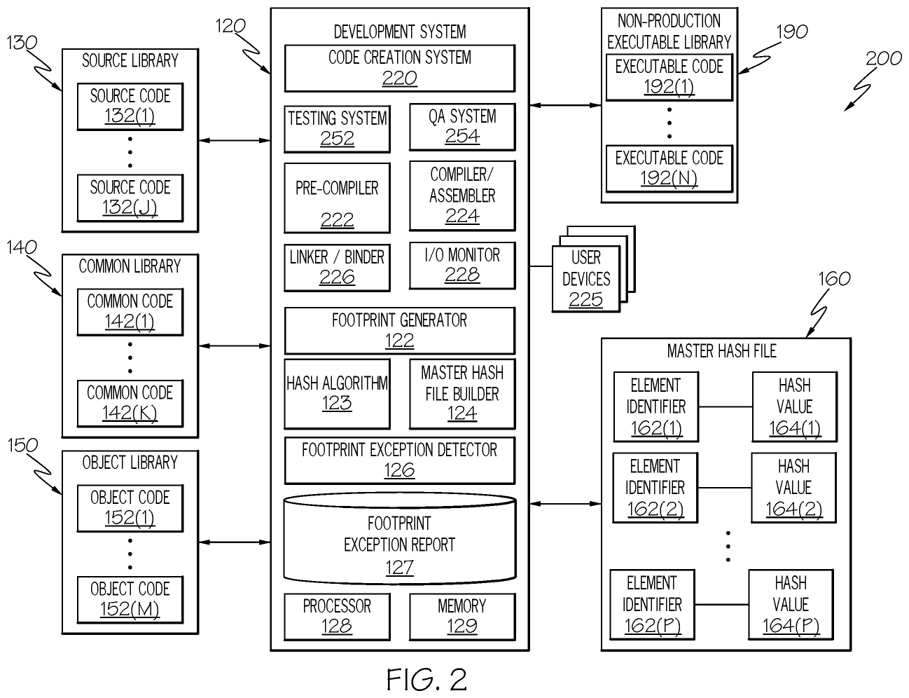

FIG. 2 is a simplified block diagram that illustrates additional possible details that may be associated with certain components of computing environment 100. Specifically, development system 120 may include various modules and components to enable software development including, but not limited to, a code creation system 220, a testing system 252, a quality assurance system 254, a pre-compiler 222, a compiler/assembler 224, a linker/binder 226, and an input/output (I/O) monitor 228. Development system 120 may also include various modules and components to implement security hardened software footprints including, but not limited to, a footprint generator 122, a hash algorithm 123, a master hash file builder 124, and a footprint exception detector 126 that can generate a footprint exception report 127. Appropriate hardware may also be provided in development system 120 including, but not necessarily limited to a processor 128 and a memory 129. Additionally, one or more user devices 225 may be authorized to access development system 120 for example, to develop, update, and maintain software elements.

Development system 120 may be communicatively coupled to one or more storage containers (e.g. 130, 140, 150, 160, 190) that contain source code, common code, object code, executable code, and a master hash file. In one example, source library 130, common library 140, object library 150, executable library 190, and possibly master hash file 160 may be implemented in a data repository, such as a database, and communicatively coupled to development system 120. Source library 130 can contain elements including source code elements 132(1)-132(J), common library 140 can contain elements including common code elements 142(1)-142(K), object library 150 can contain elements including object code elements 152(1)-152(M), and non-production executable library 190 can contain executable code that is not run on development system 120 except for testing or other non-production purposes. A master hash file 160 may include element identifiers 162(1)-162(P) and corresponding element hash values 164(1)-164(P). It should be noted that embodiments herein may be implemented in computing systems using any suitable data structures that can store code elements and a hash with each of the code elements (e.g., source, common, object, executable). For ease of illustration, however, partitioned datasets (e.g., PDS, PDS extended) in a database are illustrated and described herein.

Code creation system 220 may be hosted on development system 120 to enable authorized users (e.g., software developer) to create software programs and packages via some structured process such as a software development life cycle framework. A typical process could include several activities and computer operations. First, a source code element may be written in a desired programming language. Also, any common code elements to be incorporated in the source code element may also be written, if not already available. Second, the source code element may be pre-compiled and/or compiled or assembled into object code elements using an appropriate program such as a pre-compiler (e.g., 222) and/or compiler or assembler (e.g., 224). Third, the object code element (and possibly other object code elements) may be linked and/or bound into an executable code element (or load module) by an appropriate linker and/or binder (e.g., 226). The executable code element may be tested using testing system 252 and based on the results, the source code element and potentially common code elements incorporated by the source code may be edited to correct errors and/or improve the processing of the program. When the executable code element passes the testing stage, quality assurance may be performed by QA system 254, for example. If any corrections are needed, the source code element and possibly the incorporated common code elements may again be edited, recompiled, and relinked into an executable code element.

In at least one embodiment, the source code element may be stored in source library 130, the common code element may be stored in common library 140, the object code element may be stored in object library 150, and the executable code element (or load module) may be stored in non-production executable library 190. In at least one implementation, executable library 190 may be a non-production library and used for testing purposes, and a final (or production) version of the executable code element may be provided to a production system, such as production system 170.

Footprint generator 122 may be provisioned in development system 120 to generate a footprint for each element that is created or updated in development system 120. The footprint of an object may contain metadata that uniquely identifies the element. Metadata may include, but is not necessarily limited to, information related to the environment, the system, the subsystem, the type, and the timeframe (e.g., version, level number, and/or timestamp). The metadata may indicate where in the computing system the element is stored.

In at least one example, the footprint of a particular element may be stored with, linked to, mapped to, or otherwise associated to the element in any suitable manner. In a partitioned dataset (PDS), for example, a directory area of the PDS may be used to store footprints of each of the elements stored in the PDS. Accordingly, in at least one implementation involving PDS data structures, a directory area in source library 130 may be used to store footprints associated with source code elements 132(1)-132(J), a directory area in common library 140 may be used to store footprints associated with common code elements 142(1)-142(K), a directory area in object library 150 may be used to store footprints associated with object code elements 152(1)-152(M), and a directory area in executable library 190 may be used to store footprints associated with executable code elements 192(1)-192(N). Additional footprints may also be embedded in an executable code element in some implementations. For example, a composite executable code element may contain multiple modules (e.g., control sections or CSECTs) and a footprint for each CSECT may be generated and stored within the CSECT.

According to embodiments herein, when a footprint is created or updated for an element, a unique hash value for the element may also be included in the footprint. A hash value may be a cryptographic value, which is intended to mean a value that has been transformed from an original value such that it cannot independently be converted back to its original value. Some types of cryptography (e.g., hashing) involve one-way transformations in which the resulting cryptographic value cannot be converted back to the original value. In some other types of cryptography (e.g., encryption/decryption), a cryptographic value can be converted back to the original value (or decrypted) using a shared symmetric key if symmetric encryption was used or using one key of a key-pair if asymmetric encryption was used.

A hash algorithm (e.g., 123) may be executed to perform a hash function on the contents of the element to calculate the hash value. Examples of possible hash algorithms that may be used include, but are not necessarily limited to, a secure hash algorithm (e.g., SHA-1, SHA-2, SHA-3, etc.), or Merkle-Damgard algorithm (e.g., MDS, etc.). The calculated hash value may be stored in the footprint. In some computing systems where a footprint structure is already defined for the elements, the existing information in the footprint (e.g., metadata) may be compressed using a suitable compression technique to allow for additional bits to be made available for the hash, while not increasing the overall size of the footprint.

In another embodiment, at least some of the existing footprint information could be encoded with a look-up table to reduce the number of bits needed in the footprint for that information. For example, system and subsystem information stored in the footprint may be assigned a 2-digit numbers to identify all of the possible system and subsystem combinations. The 2-digit numbers could be stored in the appropriate footprints and when needed, the 2-digit number may be used to search the look-up table to obtain the particular system and subsystem information associated with the 2-digit number. These changes to an existing footprint structure could avoid expensive and fundamental changes to the platform's configuration. It should be apparent that compression techniques may be used in any footprint structure for some or all of the information other than the hash value in the footprint.

The calculated hash value of the element may also be stored in master hash file 160. The master hash file could be implemented in any number of suitable ways. In one example, a hash value (and remaining part of the footprint) may be stored in a component list that is used to track elements processed in computing environment 100. A component list may include a record for every element and the hash values and other information in footprints of elements may be stored in the appropriate records. In another example, a separate dataset in the database comprising the element libraries may be used to store the hash values and element identifiers. In at least some implementations, an XOR table may provide fast look-up for hash values based on the associated element identifiers or vice versa.

In master hash file 160, the calculated hash value of an element may be mapped, linked, or otherwise associated with an element identifier (e.g., 162(1)-162(P)) that uniquely identifies the element of the hash value. In one example, the element identifier may be derived from the metadata in the footprint of the element and may include at least some of the metadata. For example, an element identifier may be some combination of library, member/file name, and possibly the hash value. In other examples, a key (e.g., unique symbol or special characters) could be generated for each element and stored in the footprint, and this key could be used as an element identifier.

Footprint exception detector 126 can be provided in development system 120 to enable detection of compromised elements. Footprint exception detector 126 may include one or more components for validating an element or elements at various times. In a first scenario, an element or elements may be validated each time the element or elements are used to generate a lower-level element. In particular, when a source code element and possibly one or more common code elements are compiled or assembled to generate an object code element, the source code element and the one or more common code elements may be validated. Similarly, when one or more object code elements are linked and/or bound to generate an executable code element, the one or more object code elements may be validated.

In a second scenario of validating elements, one or more libraries (e.g., PDS, PDS/E, etc.) may be validated on demand or according to a specified schedule. For example, a source library, a common library, or an object library may be selected for validation either on-demand or based on a schedule. In another example, an executable library (e.g., loadlib, etc.) may be selected for validation either on-demand or based on a schedule. In some scenarios, when an executable library is selected and an executable code element in the selected library is validated, each submodule (e.g., CSECT) found in the executable code element may also be validated. In some alternative embodiments, one or more specified elements may be validated on demand or according to a specified schedule, rather than specified libraries of elements.

In a third scenario of validating elements, an element may be validated when an access request (e.g., read, move, delete, execute, quarantine access, etc.) of the element is detected. This may occur, for example, when execution of an executable code element (e.g., 192(1)-192(N)) is initiated. Prior to execution, a validation procedure may be performed. If the validation is successful, then the execution may proceed. If the validation is not successful, then the validation failure may be logged in footprint exception report 127 as further described herein. In addition, the execution may be blocked, and/or an alert may be sent to enable user intervention, for example. Any other suitable action may also or alternatively be taken.

It should be noted that, in at least some embodiments, when validating a particular element on demand, on a schedule, or in real-time as a result of an access request, if validation fails for the particular element, then the higher-level elements used to generate the particular element may also be validated. For example, if an object code element is selected for validation, but the validation fails, then a validation procedure may be applied to each of the source code element and any common code elements copied into the source code element, which were compiled to generate the selected object code element. Similarly, if an executable code element is selected for validation, but the validation fails, then a validation procedure may be applied to each of the object code elements that were linked/bound to generate the executable code element. If validation fails for any of those object code elements, then a validation procedure may be applied to each of the source code and common code elements used to generate those object code elements.

In at least one embodiment, a three-way validation procedure may be performed. The hash algorithm (e.g., 123) is applied to the contents of an element that is selected for validation to calculate a hash value of the contents. The hash value in the footprint of the element is identified and compared to the calculated hash value. If the comparison fails, then the contents have likely been compromised. If the comparison does not fail, then an additional check may be performed based on a stored hash value corresponding to the selected element and stored in the master hash file (e.g., 160). In at least one embodiment, a comparison fails if the values being compared do not match or otherwise correspond (e.g., complementary values, etc.) to each other, and a comparison succeeds if the values being compared match or otherwise correspond to each other. The master hash file may be searched based on an element identifier of the selected element. In one embodiment, the element identifier may contain at least some of the metadata information stored in the footprint of the selected element. A search may be performed on the master hash file based on the element identifier of the selected element. Upon finding a corresponding element identifier (e.g., 162(1)-162(P)) in the master hash file, an associated stored hash value (e.g., 164(1)-164(P)) may be compared to either the calculated hash value or the hash value of the footprint. If the comparison fails, then the contents of the element have likely been compromised and appropriate action may be taken as previously described herein.

Footprint exception report 127 may be provided to log exceptions that are detected during validation procedures. Accordingly, when an exception is detected (e.g., when a validation comparison fails), information related to the exception may be recorded in the footprint exception report 127. For example, an identification of the element may be included. The identification may be derived from metadata in the footprint of the element in at least one example. An indication of the comparison failure may be included, which can identify which comparison (or comparisons) failed. Any other relevant information may be included based on particular needs, preferences, and implementations.

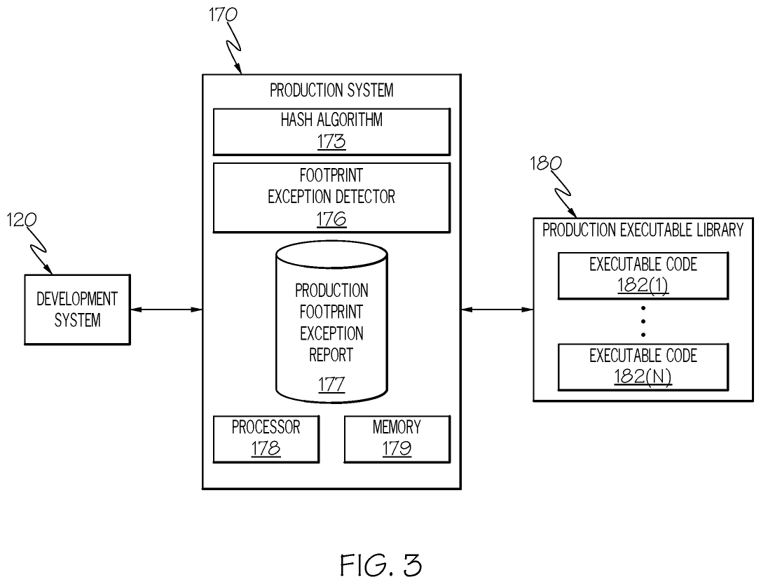

FIG. 3 is a simplified block diagram that illustrates additional possible details that may be associated with certain components of computing environment 100. Generally, production system 170 may include any appropriate software, hardware, and firmware to enable production software to run. Production system 170 may be communicatively coupled to a data repository (e.g., 120) and may contain production software, such as production executable library 180 containing executable code elements 182(1)-182(N). Production system 170 may include a hash algorithm 173 for performing a validation procedure on executable code elements 182(1)-182(N) and may also include a production footprint exception detector 176 that can generate a production footprint exception report 177. Appropriate hardware may also be provided in production system 170 including, but not necessarily limited to a processor 178 and a memory 179.

In some implementations, production system 170 may be remotely located from development system 120, and may receive production executable code elements (e.g., 182(1)-182(N)) from development system 120. For example, executable code elements 192(1)-192(N) in non-production executable library 190 coupled to development system 120 may be provided to production system 170 upon the successful completion of testing and quality assurance processes on the executable code elements 192(1)-192(N).

Footprint exception detector 176 can be provided in production system 170 to enable detection of compromised elements in the production software. Footprint exception detector 176 may include one or more components for validating an executable code element or elements at various times. In a first scenario, an executable code element or elements (e.g., 182(1)-182(N)) may be validated on demand or according to a specified schedule. For example, an executable code element in production execution library 180 may be selected for validation either on-demand or based on a scheduled process. In some scenarios, it may be beneficial to validate the selected executable code element and/or to validate each of the CSECTs that are included in the selected executable code element.

In a second scenario of validating elements, an executable code element of production executable library 180 may be validated when an access request of the element is detected. This may occur, for example, when execution of an executable code element (e.g., 182(1)-182(N)) is invoked. Prior to execution, a validation procedure may be performed. If the validation is successful, then the execution may proceed. If the validation is not successful, then the validation failure may be logged in production footprint exception report 177, as further described herein. Furthermore, the execution may be blocked or logged, and/or an alert may be sent to enable user intervention, for example. Any other suitable action may also or alternatively be taken.

In at least one embodiment, a three-way validation procedure may be performed, as previously described herein. The hash algorithm (e.g., 173) is applied to the contents of an executable code element (e.g., 182(1)-182(N)) that is selected for validation to calculate a hash value of the contents. The hash value in the footprint of the executable code element is identified and compared to the calculated hash value. If the comparison fails, then the contents have likely been compromised. If the comparison did not fail, then an additional check may be performed based on a stored hash value corresponding to the selected element and stored in the master hash file (e.g., 160) coupled to development system 120. Production server may send a request to development system 120 to request validation of the calculated hash value (or production footprint hash value) based on an element identifier of the selected element in the master hash file.

Development system 120 can search the master hash file based on the element identifier received in the request from production system 170. In one embodiment, the element identifier may contain at least some of the metadata information stored in the footprint of the selected element. If a corresponding element identifier (e.g., 162(1)-162(P)) is found in the master hash file, an associated stored hash value (e.g., 164(1)-164(P)) may be compared to either the calculated hash value or the hash value of the footprint of the selected element. The calculated hash value and/or the hash value of the footprint of the selected element may be received by the development system in the request from the production system. Development system 120 can provide production system 170 with the results of the search and comparison, which can include an indication of whether the search was successful (e.g., a corresponding element identifier was found in the master file list). If the search was successful, the results can also include an indication of whether the comparison succeeded or failed. In other implementations, master hash file 160 could be accessible over a wide area network (e.g., in a cloud database) and may be queried directly by production system 170.

Based at least in part on the results received from development system 120, production system 170 can produce production footprint exception report 177, which can include a log of exceptions that are detected during validation procedure. Accordingly, when an exception is detected (e.g., when a validation comparison fails as indicated in the results received from development system 120), information related to the exception may be recorded in the production footprint exception report 177. For example, an identification of the element may be included. The identification may be derived from metadata in the footprint of the executable code element in at least one example. An indication of the comparison failure may be included, which can identify which comparison (or comparisons) failed. Any other relevant information may be included based on particular needs, preferences, and implementations. In addition, if the results indicate that the validation was not successful, then the execution may be blocked, and/or an alert may be sent to enable user intervention, for example. Any other suitable action may also or alternatively be taken.

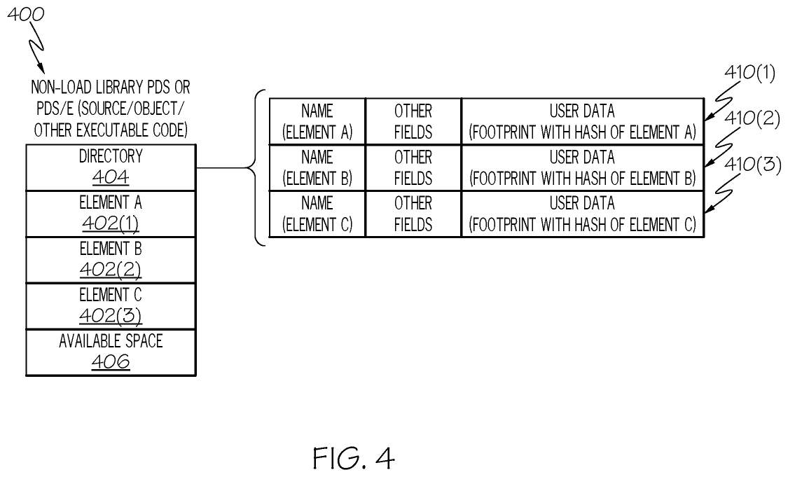

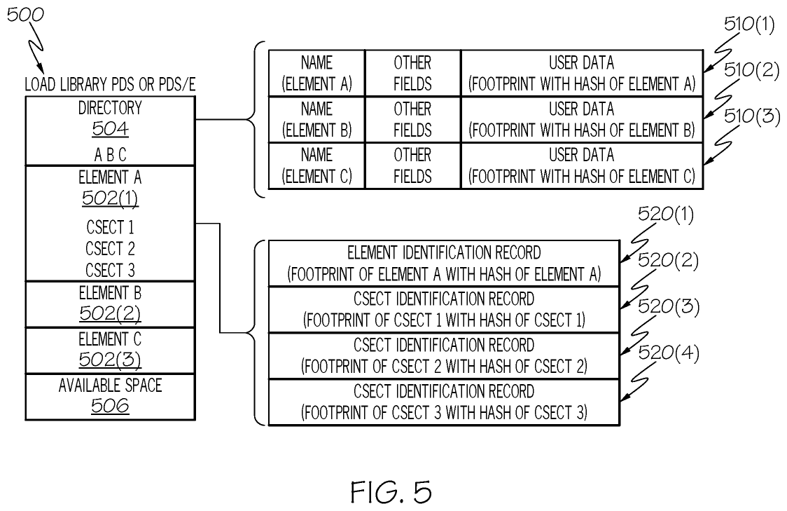

FIGS. 4 and 5 offer simplified block diagrams of possible details of example datasets that may be used in at least one embodiment of the present disclosure. FIG. 4 is a simplified block diagram an example dataset 400, shown as a partitioned dataset (PDS) or partitioned dataset extended (PDS/E) for a non-load library. Dataset 400 is one possible example for implementing source library 130, common library 140, and object library 150 in accordance with embodiments described herein.

Dataset 400 includes a directory 404, elements 402(1), 402(2), and 402(3), and available space 406. As a source library, elements A, B, and C of dataset 400 may be source code elements (e.g., 132(1)-132(J)). As a common library, elements A, B, and C of dataset 400 may be common code elements (e.g., 142(1)-142(K)). As an object library, elements A, B, and C of dataset 400 may be object code elements (e.g., 152(1)-152(M)). Directory 404 can be used to store footprints of the elements 401(1)-402(3) stored in dataset 400. Directory 404 can include blocks of data, with each block corresponding to an element in the dataset. In dataset 400, a first block 410(1) corresponds to element A 402(1), a second block 410(2) corresponds to element B 402(2), and a third block 410(3) corresponds to element C 402(3). Each block may include an element name (or identifier), other fields, and user data. The user data can be used to store footprints associated with the elements. A footprint with a hash value of the contents of element A may be stored in the user data of block 410(1). A footprint with a hash value of the contents of element B may be stored in the user data of block 410(2). A footprint with a hash value of the contents of element C may be stored in the user data of block 410(3).

FIG. 5 is a simplified block diagram an example dataset 500, shown as a partitioned dataset (PDS) or partitioned dataset extended (PDS/E) for a load library. Dataset 500 is one possible example for implementing non-production executable library 190 and production executable library 180 in accordance with embodiments described herein. Dataset 500 includes a directory 504, elements 502(1), 502(2), and 502(3), and available space 506. As an executable library, elements A, B, and C may be executable code elements, such as executable code elements 192(1)-192(N) of non-production executable library 190 or executable code elements 182(1)-182(N) of production executable library 180.

Directory 504 can be used to store footprints of elements 501(1)-502(3) stored in dataset 500. Directory 504 can include blocks of data, with each block corresponding to an element in the dataset. In dataset 500, a first block 510(1) corresponds to element A 502(1), a second block 510(2) corresponds to element B 502(2), and a third block 510(3) corresponds to element C 502(3). Each block may include an element name (or identifier), other fields, and user data. The user data can be used to store footprints associated with the elements. A footprint with a hash value of the contents of element A may be stored in the user data of block 510(1). A footprint with a hash value of the contents of element B may be stored in the user data of block 510(2). A footprint with a hash value of the contents of element C may be stored in the user data of block 510(3).

In addition to the footprints stored in directory 504, footprints may also be stored in the executable code of the elements. In one example, an executable code element may contain one or more modules, referred to herein as control sections or CSECTs. Each element and each CSECT within each element may contain a record, such an identification record, in which footprints with hash values may be stored. For example, with reference to element A 502(1), CSECT 1, CSECT 2, and CSECT 3 are shown. An identification record 520(2) is provided in CSECT 1 and can contain a footprint of CSECT 1 including a hash value of the contents of CSECT 1. An identification record 520(3) is provided in CSECT 2 and can contain a footprint of CSECT 2 including a hash value of the contents of CSECT 2. An identification record 520(4) is provided in CSECT 3 and can contain a footprint of CSECT 3 including a hash value of the contents of CSECT 3. The footprints of the CSECTs may contain similar information as previously described herein with reference to footprints of elements. An identification record 520(1) is also provided in element A and can contain a footprint of element A including a hash value of the contents of element A. The hash value may be computed over all of the contents of element A, including CSECT 1, 2, and 3. In some embodiments, the footprint with the hash value in element identification record 520(1) may be the same as the footprint with hash value of element A stored in block 510(1) of directory 504.

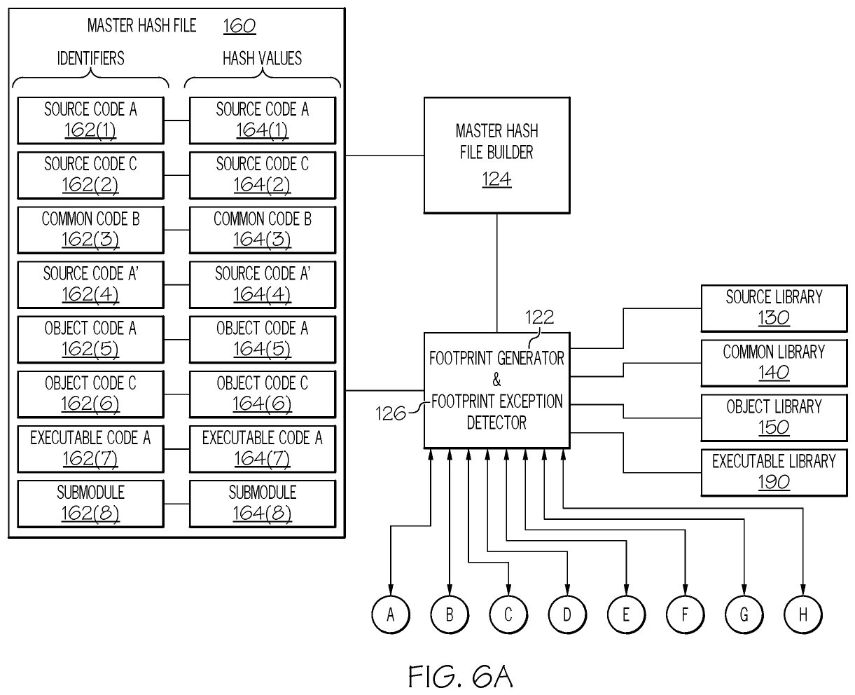

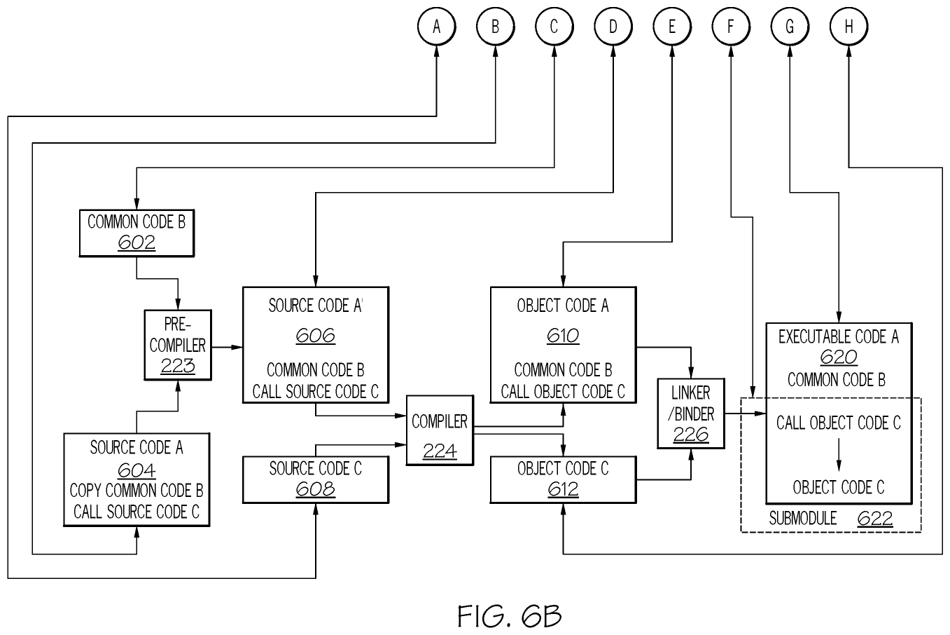

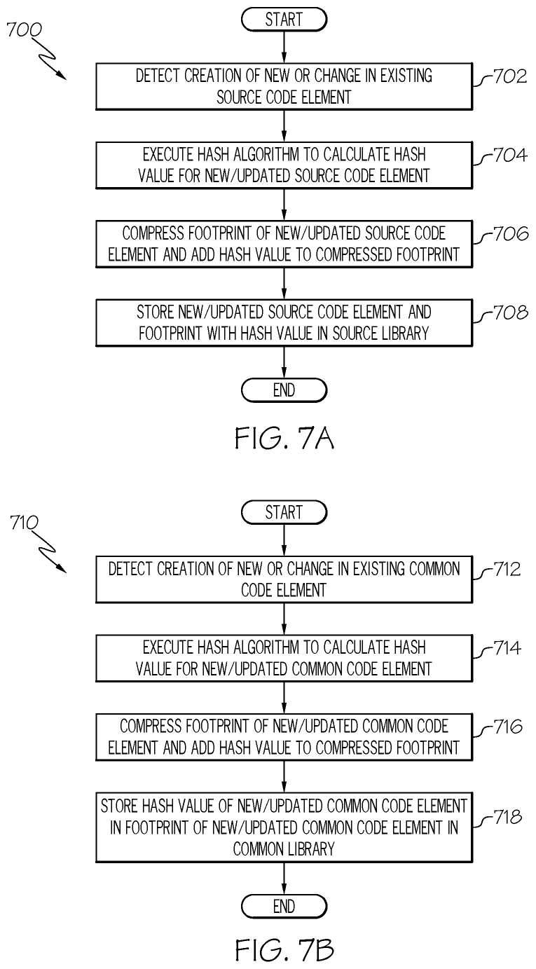

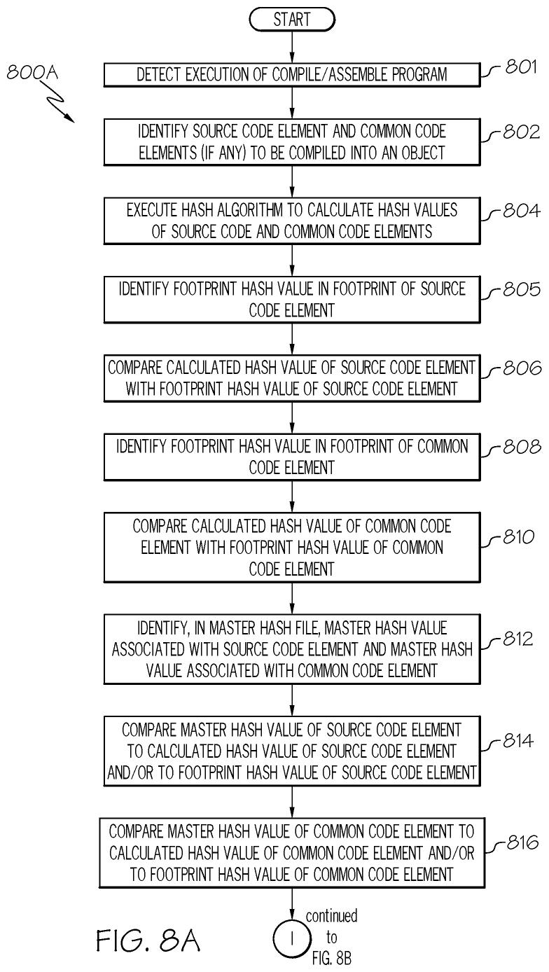

FIGS. 6A-6B show a simplified block diagram illustrating an example operation flow for creating an executable code element, executable code A 620, generating footprints with hash values, and validating elements. The operation flow shown in FIGS. 6A-6B involves several elements including, common code B 602, source code A 604, source code A′ 606, source code C 608, object code A 610, and executable code A 620. In this example, source code A 604 includes an instruction to copy some common code into source code A 604 to be compiled. Source code A also includes an instruction to call another program, such as source code C 608.

Initially, when an element is created (and also at any subsequent updates), footprint generator 122 may generate footprints with hash values for each of the elements. Specifically, footprint generator 122 may collect metadata (e.g., environment, system, subsystem, type, timeframe) of the element for the footprint. In one or more embodiments, a suitable compression technique may be applied to some or all of the metadata to minimize the amount of space it consumes in the footprint. A hash algorithm (e.g., 123) is applied to the contents of the element to calculate a hash value to be included in the footprint. Master hash file builder 124 can store and map (or otherwise associate), in the master hash file 160, an identifier of the element and the hash value of the element. The element identifier may be derived from at least some of the metadata in the footprint generated for element A.

Accordingly, when source code A 604 is created or updated, a footprint is generated with metadata and a hash value calculated for the contents of source code A. Source code A can be stored in source library 130. An identifier 162(1) of source code A can be derived from the metadata in the footprint of source code A, and a hash value 164(1) can be obtained from the calculated hash value in the footprint of source code A. Identifier 162(1) can be stored in master hash file 160 and mapped (or otherwise associated) to hash value 164(1).

Similarly, when source code C 608 is created or updated, a footprint is generated with metadata and a hash value calculated for the contents of source code C. Source code C can be stored in source library 130. An identifier 162(2) of source code C can be derived from the metadata in the footprint of source code C, and a hash value 164(2) can be obtained from the calculated hash value in the footprint of source code C. Identifier 162(2) can be stored in master hash file 160 and mapped (or otherwise associated) to hash value 164(2).

When common code B 602 is created or updated, a footprint is generated with metadata and a hash value calculated for the contents of common code B. Common code B can be stored in common library 140. An identifier 162(3) of common code B can be derived from the metadata in the footprint of common code B, and a hash value 164(3) can be obtained from the calculated hash value in the footprint of common code B. Identifier 162(3) can be stored in master hash file 160 and mapped (or otherwise associated) to hash value 164(3).

When a process (e.g., pre-compile, compile, assemble, link, bind, etc.) is applied to one or more higher-level elements to transform the one or more elements into a lower-level element, a validation procedure that includes two hash comparisons may be applied to each of the one or more higher-level elements. In an example validation procedure for one of the higher-level elements, a hash algorithm (e.g., 123) is applied to the contents of the higher-level element to calculate a hash value of the contents. The hash value in the footprint of the higher-level element is identified and compared to the calculated hash value. If the first comparison fails, then the higher-level element is determined to be compromised. If the first comparison does not fail, then a second comparison may be performed based on a stored hash value that corresponds to the higher-level element and that is stored in a master hash file (e.g., 160). The master hash file may be searched based on an element identifier of the higher-level element. In one embodiment, the element identifier may contain at least some of the metadata information stored in the footprint of the higher-level element. Upon finding a corresponding element identifier (e.g., 162(1)-162(P)) in the master hash file, an associated stored hash value (e.g., 164(1)-164(P)) may be compared to either the calculated hash value or the hash value of the footprint of the higher-level element. If the second comparison fails, then the contents of the higher-level element are determined to be compromised and the validation procedure fails.

If a validation procedure fails for any higher-level element, then an exception is raised for the process (e.g., pre-compile, compile, assemble, link, bind, etc.) and any appropriate actions may be taken in response to the validation failure. For example, the validation failure may be logged in an audit file, a text message alert may be sent to notify appropriate individuals, an error message may be displayed on one or more user terminals coupled to the development system, the process being performed (e.g., pre-compile, compile, assemble, link, bind) may be blocked until the unvalidated higher-level element is successfully validated or until an authorized user overrides the block. Furthermore, any other actions implemented in the system may be taken in addition to, or alternative to, one or more of the previously enumerated actions. In addition, a footprint exception report may be generated or updated to include information related the validation failure including identifying information of the higher-level element that caused the validation procedure to fail.

With reference to the example in FIG. 6A, a pre-compiler 223 may be invoked for source code A 604. The validation procedure may be applied to source code A and any common code to be copied into source code A. Thus, in this scenario, the validation procedure may be applied to common code B 602. If validation is successful for both source code A and common code B, then pre-compiler 223 may be executed to create source code A′ 606. Pre-compiler 223 can cause common code B 602 to be copied into source code A′ 606. If the validation procedure fails for either source code A or common code B, then any appropriate actions may be taken in response to the validation failure as previously described. It should be noted that different programming languages may use different instructions to incorporate common code into source code. Examples of instructions in various programming languages to incorporate common code into source code include a COPY instruction, an INCLUDE instruction, a coded Macro or common code name, etc.

When source code A′ 606 is created (or updated) by pre-compiler 223, a footprint is generated with metadata and a hash value calculated for the contents of source code A′. Source code A′ can be stored in source library 130. An identifier 162(4) of source code A′ can be derived from the metadata in the footprint of source code A′, and a hash value 164(4) can be obtained from the calculated hash value in the footprint of source code A′. Identifier 162(4) can be stored in master hash file 160 and mapped (or otherwise associated) to hash value 164(4).

Compiler/assembler 224 may be invoked for source code A′ 606. The validation procedure may be applied to source code A′ and any source code called by source code A′. Thus, in this scenario, the validation procedure may be applied to source code C 608. If validation is successful for both source code A′ and source code C, then compiler/assembler 224 may be executed to create object code A 610. Compiler/assembler 224 also transforms source code C into object code C 612. If the validation procedure fails for either source code A′ or source code C, then any appropriate actions may be taken in response to the validation failure as previously described.

When object code A 610 is created (or updated) by compiler/assembler 224, a footprint is generated with metadata and a hash value calculated for the contents of object code A. Object code A can be stored in object library 150. An identifier 162(5) of object code A can be derived from the metadata in the footprint of object code A, and a hash value 164(5) can be obtained from the calculated hash value in the footprint of object code A. Identifier 162(5) can be stored in master hash file 160 and mapped (or otherwise associated) to hash value 164(5).

When object code C 612 is created (or updated) by compiler 224, a footprint is generated with metadata and a hash value calculated for the contents of object code C. Object code C can be stored in object library 150. An identifier 162(6) of object code C can be derived from the metadata in the footprint of object code C, and a hash value 164(6) can be obtained from the calculated hash value in the footprint of object code C. Identifier 162(6) can be stored in master hash file 160 and mapped (or otherwise associated) to hash value 164(5).

Linker/binder 226 may be invoked for object code A 610. The validation procedure may be applied to object code A and any other object code elements called by object code A. Thus, in this scenario, the validation procedure may be applied to object code C 612. If validation is successful for both object code A and object code C, then linker/binder 226 may be executed to create executable code A 620. Linker/binder 226 may also transform object code C into a submodule (or CSECT) 622 of executable code 620. If the validation procedure fails for either object code A or object code C, then any appropriate actions may be taken in response to the validation failure as previously described.

When executable code A 620 is created (or updated) by compiler/assembler 224, a footprint is generated with metadata and a hash value calculated for the contents of executable code A. Executable code A and its footprint can be stored in executable library 190. An identifier 162(7) of executable code A can be derived from the metadata in the footprint of executable code A, and a hash value 164(7) can be obtained from the calculated hash value in the footprint of executable code A. Identifier 162(7) can be stored in master hash file 160 and mapped (or otherwise associated) to hash value 164(7).

When executable code A 620 is created (or updated) by compiler/assembler 224, and one or more submodules (or CSECTs) are created in the executable code, a footprint for each submodule may be generated with metadata of the submodule and a hash value calculated for the contents of the submodule. In the scenario shown in FIGS. 6A-6B, submodule 622 is created in executable code A. Accordingly, a footprint is generated for submodule 622. Submodule 622 and its footprint can be stored in executable library 190 with executable code A. In at least one embodiment, the footprint of a submodule may be stored in the submodule itself (e.g., in an identification record of the submodule) rather than the directory of the executable library 190. An identifier 162(8) of submodule 622 can be derived from the metadata in the footprint of submodule 622, and a hash value 164(8) can be obtained from the calculated hash value in the footprint of submodule 622. Identifier 162(8) can be stored in master hash file 160 and mapped (or otherwise associated) to hash value 164(8).

Turning to FIGS. 7A-7B, simplified flowcharts 700 and 710 illustrate example techniques involved in generating or updating a hash value of the highest-level elements, such as source code and common code. In at least one embodiment, one or more operations correspond to activities of each of FIGS. 7A and 7B. In one example, a development system (e.g., 120), or a portion thereof, may perform at least some of the one or more operations associated with each flowchart. The development system may comprise means, such as processor 128 and memory 129, for performing the operations. In an embodiment, one or more operations of each of the flows of FIGS. 7A and 7B may be performed by a footprint generator (e.g., 122).

In flowchart 700, at 702, the creation of a new source code element or the update of an existing source code element may be detected. At 704, a hash algorithm may be executed to calculate a hash value for the contents of the new or updated source code element. At 706, a footprint generated for the new or updated source code element can be compressed (if needed) and the hash value can be added to the compressed footprint. At 708, the new or updated source code element and the compressed footprint containing the hash value can be stored in the source library (e.g., 130). In an example, the footprint with the hash value of the source code element may be stored in a directory of the source library.

In flowchart 710, at 712, the creation of a new common code element or the update of an existing common code element may be detected. At 714, a hash algorithm may be executed to calculate a hash value for the contents of the new or updated common code element. At 716, a footprint generated for the new or updated common code element can be compressed (if needed) and the hash value can be added to the compressed footprint. At 718, the new or updated common code element and the compressed footprint containing the hash value can be stored in the common library (e.g., 140). In an example, the footprint with the hash value of the common code element may be stored in a directory of the common library.

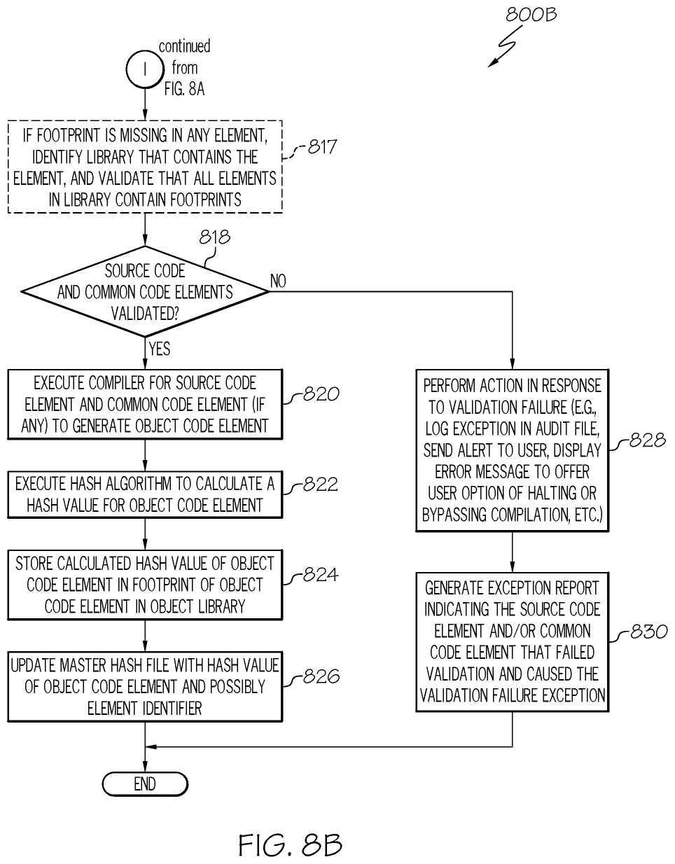

Turning to FIGS. 8A-8B, simplified flowcharts 800A and 800B illustrate example techniques involved in performing validation procedures when a source code element and one or more common code elements are to be compiled or assembled into one or more object code elements. In at least one embodiment, one or more operations correspond to activities of FIGS. 8A and 8B. In one example, a development system (e.g., 120), or a portion thereof, may perform at least some of the one or more operations. The development system may comprise means, such as processor 128 and memory 129, for performing the operations. In an embodiment, one or more operations of flows of FIGS. 8A and 8B may be performed by a footprint exception detector (e.g., 126), a footprint generator (e.g., 122), and/or a compiler or assembler (e.g., 224).

In flowchart 800A, at 801, an execution of a compile program is detected. At 802, a source code element and any common code elements to be compiled into an object code element are identified. In at least one embodiment, the source code elements and the common code elements may be identified during compiler/assembler execution. The common code elements can be identified through the use of a “SCREEN” program or an input/output (I/O) exit to automatically detect included elements, or in certain cases, based on parsing the instructions within the source code element to find each instance of an instruction to copy a common code element. Although multiple common code elements may be identified in a source code element, and a validation procedure may be performed for each identified common code element as further described herein, for ease of reference, FIGS. 8A-8B are shown and described based on a scenario in which a single instance of an instruction to copy a common code element is identified in the source code.

At 804, a hash algorithm may be executed to calculate a hash value of the contents of the source code element. The hash algorithm may also be executed for each identified common code element to calculate a hash value of the contents of each identified common code element.

At 805, a hash value in a footprint of the source code element is identified. At 806, the calculated hash value of the source code element is compared to the footprint hash value of the source code element.

At 808, a hash value in a footprint of the common code element is identified. At 810, the calculated hash value of the common code element is compared to the footprint hash value of the common code element.

At 812, a master hash file can be searched for hash values associated with the source code element and the common code element. In one or more embodiments, at least some metadata from the footprint of the source code element can be used to search element identifiers, which are associated to hash values, in the master hash file. Similarly, at least some metadata from the footprint of the common code element can be used to search the element identifiers in the master hash file. If the element identifiers are located based on the metadata from the footprints, then the hash values from the master hash file corresponding to the source code element and the common code element can be identified.

At 814, the master hash value of the source code element is compared to the calculated hash value of the source code element and/or to the footprint hash value of the source code element. In some implementations, the comparison against the hash value in the master hash file of the source code element may not be performed if the comparison between the footprint hash value and the calculated hash value of the source code element fails, since this prior comparison failure indicates the source code element is compromised and therefore, the validation of the source code element already failed. Also, in some implementations, when the comparison between the footprint hash value and the calculated hash value of the source code element succeeds, then the comparison with the master hash value of the source code element may be made against only one of the footprint hash value and the calculated hash value of the source code element.

At 816, the master hash value of the common code element is compared to the calculated hash value of the common code element and/or to the footprint hash value of the common code element. In some implementations, the comparison against the hash value in the master hash file of the common code element may not be performed if the comparison between the footprint hash value and the calculated hash value of the common code element fails, since this prior comparison failure indicates the common code element is compromised and therefore, the validation of the common code element already failed. Also, in some implementations, when the comparison between the footprint hash value and the calculated hash value of the common code element succeeds, then the comparison with the master hash value of the common code element may be made against only one of the footprint hash value and the calculated hash value of the common code element.

In flowchart 8006, at 817, an optional feature is illustrated and may be performed based on determining a footprint is missing in one or more elements. For this optional feature, if a footprint is missing in any element (e.g., source code element, common code element), then the library that contains the element may be identified. A check is performed in the identified library to determine whether any other elements in that library are also missing a footprint. If the library is found to contain a mixture of footprinted and un-footprinted elements a caution exception may be raised, and/or an audit log may be created indicating that potentially compromised software is present in the library and identifying any elements that have missing or invalid footprint information. For footprints that contain other identifying information (e.g., ISPF element statistics), this data may also be included in the log). This check may be performed for each library containing one of the elements that does not have a footprint.

At 818, a determination can be made as to whether the validation procedure for each of the elements to be compiled (e.g., source code element, common code element) was successful. For example, in a validation procedure of a particular element, if both of the hash value comparisons succeed, then the validation procedure for that element is successful and the element is validated. If one of the hash value comparisons fails for a particular element, then the validation procedure for that element is not successful and the element is not validated. In at least one embodiment, a comparison of hash values succeeds if the hash values match or if the hash values otherwise correspond to each other based on the particular implementation (e.g., if the hash values are complementary values, etc.). If the elements to be compiled are validated, then the compile process may proceed. If any of the elements to be compiled are not validated, however, then an exception for the compiler (or assembler) process may be raised based on the validation failure.

If all of the elements to be compiled are validated, then at 820, a compiler may be executed for the source code element. The common code element is copied into the source code element and the source code element is compiled into an object code element. Compiling the source code element can include converting the source code into a machine-code or lower-level form that can be read by a computer. A footprint containing metadata of the object code element may also be generated.

At 822, a hash algorithm is executed to calculate a hash value for the contents of the object code element. At 824, the object code element is stored in an object library and the hash value of the object code element is stored in the footprint of the object code element, which is also stored in the object library. In one example, the footprint with the hash value of the object code element may be stored in a directory of the object library. It should also be noted that the metadata (or portions thereof) in the footprint may be compressed using appropriate compression techniques to provide space in the footprint data structure to store the hash value of the object code element.

At 826, a master hash file may be updated with the hash value of the object code element and linked, mapped, or otherwise associated to an identifier of the object code element. If the identifier of the object code element is not already stored in the master hash file, then it may be added to the master hash file.

With reference again to 818, if one or more of the validation procedures performed on the elements to be compiled (e.g., source code element, common code elements) fail (e.g., if any of the hash value comparisons fail), then the one or more elements of the one or more failed validation procedures are not validated. In this scenario, an exception to the compiler (or assembler) process may be raised based on the validation failure. Generally, an exception is an event that disrupts the normal flow of instruction execution in a processor. At 828, one or more actions may be performed in response to the validation failure. For example, the exception may be logged in an audit file, an alert may be generated (e.g., text message sent to notify appropriate individuals), an error message may be displayed on one or more user terminals coupled to the development system, and/or the compilation may be blocked until the validation failure is corrected (e.g., the compromised element is updated with uncompromised contents) and the compilation is restarted, or until an authorized user bypasses the block by manually deleting the footprint information for the compromised element. In this case any element without a footprint could be flagged in the footprint exception reports until corrected. Furthermore, any other actions implemented in the system may be taken in addition to or alternative to the previously enumerated actions.

At 830, an exception report (e.g., 127) may be generated to identify the source code element and/or the common code element(s) that failed validation and caused the validation failure exception.

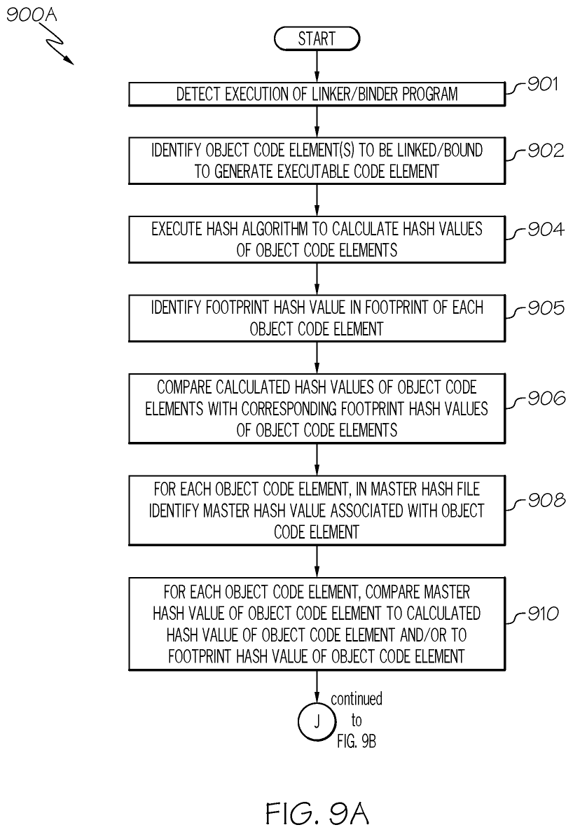

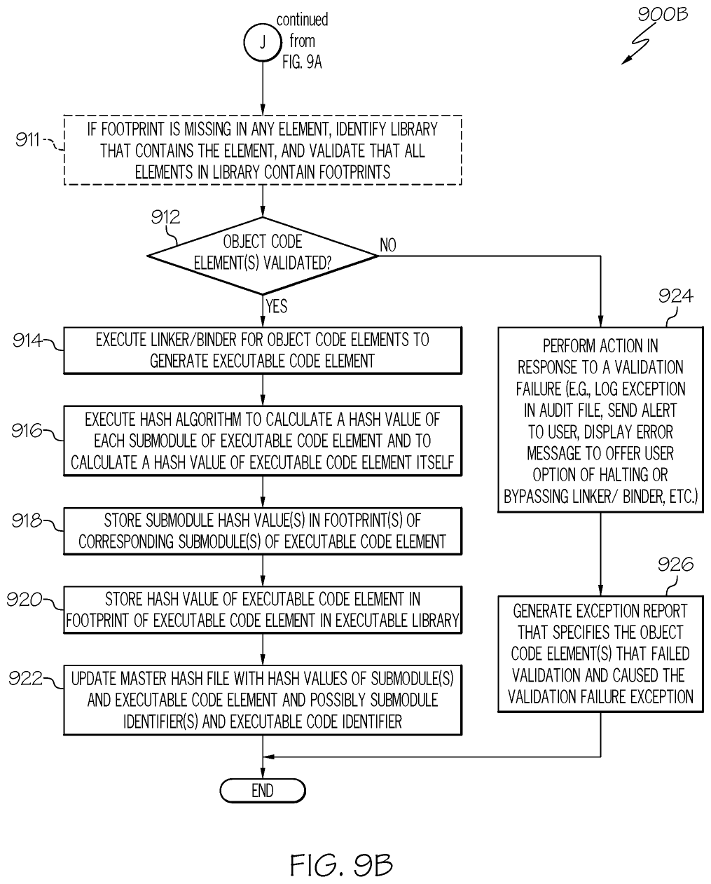

Turning to FIGS. 9A-9B, simplified flowcharts 900A and 900B illustrate example techniques involved in performing validation procedures when one or more object code elements are to be linked/bound into an executable code element. In at least one embodiment, one or more operations correspond to activities of FIGS. 9A and 9B. In one example, a development system (e.g., 120), or a portion thereof, may perform at least some of the one or more operations. The development system may comprise means, such as processor 128 and memory 129, for performing the operations. In an embodiment, one or more operations of the flows of FIGS. 9A and 9B may be performed by a footprint exception detector (e.g., 126), a footprint generator (e.g., 122), and/or a linker and/or binder (e.g., 226).

In flowchart 900A, at 901, an execution of a linker/binder program is detected. At 902, a main object code element to be linked/bound to generate an executable code element is identified. In at least one embodiment, the object code elements may be identified during the execution of the linker/binder. In some linker/binder implementations, such as static linking for example, object code elements can be identified through the use of a “SCREEN” or input/output (I/O) exit to determine object code and called object code relationships. Although a single object code element could be linked/bound to generate an executable code element, for illustration purposes, FIG. 9 will be described based on a scenario in which the main object code element calls one or more other object code elements. Accordingly, the main object code element is to be linked/bound with the other object code elements to generate the executable code element.

At 904, a hash algorithm may be executed to calculate a hash value of the contents of the main object code element. The hash algorithm may also be executed for each of the other object code elements called by the main object code element.

At 905, a hash value in a footprint of each object code element (e.g., the main object code element and the other object code elements called by the main object code element) are identified. At 906, the calculated hash values of the object code elements are compared to the footprint hash values of the corresponding object code elements.

At 908, a master hash file can be searched for hash values associated with the main object code element and the called object code elements. In at least one embodiment, metadata from the footprint of the main object code element can be used to search element identifiers, which are associated to hash values, in the master hash file. Similarly, metadata from the footprints of the called object code elements can be used to search the element identifiers in the master hash file. If the element identifiers are located based on the metadata from the footprints, then the hash values from the master hash file corresponding to the main object code element and the called object code elements can be identified.

At 910, the master hash value of each object code element (e.g., the main object code element and the called object code elements) is compared to the calculated hash value of the that object code element and/or to the footprint hash value of that object code element. In some implementations, the comparison against a hash value in the master hash file of an object code element may not be performed if the comparison between a footprint hash value and a calculated hash value of the object code element fails, since this prior failed comparison indicates that the object code element is compromised and therefore, the validation of the object code element failed. Also, in some implementations, when the comparison between the footprint hash value and the calculated hash value of the object code element succeeds, then the comparison with the master hash value of the object code element may be made against only one of the footprint hash value or the calculated hash value of the object code element.

In flowchart 9006, at 911, an optional feature is illustrated and may be performed based on determining a footprint is missing in one or more elements. For this optional feature, if a footprint is missing in any element (e.g., main object code element, other object code elements), then the library that contains the element may be identified. A check is performed in the identified library to determine whether any other object code elements in that library are also missing a footprint. If the library is found to contain a mixture of footprinted and un-footprinted object code elements a caution exception may be raised, and/or an audit log may be created indicating that potentially compromised software is present in the library and identifying any object code elements that have missing or invalid footprint information. For footprints that contain other identifying information (e.g., ISPF element statistics), this data may also be included in the log). This check may be performed for each library containing one of the object code elements that does not have a footprint.

At 912, a determination can be made as to whether the validation procedure for each of the elements to be linked and/or bound (e.g., main object code element, other object code elements) was successful. For example, in a validation procedure of a particular element, if both of the hash value comparisons succeed, then the validation procedure for that element is successful and the element is validated. If one of the hash value comparisons fail for a particular element, then the validation procedure for that element is not successful and the element is not validated. In at least one embodiment, a comparison of hash values succeeds if the hash values match or if the hash values otherwise correspond to each other based on the particular implementation (e.g., if the hash values are complementary values, etc.). If all of elements to be linked and/or bound are validated, then the linker/binder process may proceed. If any of the elements to be linked and/or bound are not validated, however, then an exception for the linker/binder process may be raised based on the validation failure.

If the validation procedures are successful, then at 914, a linker/binder (e.g., 226) may be executed for the main object code element. The linker/binder can combine the main object code element with the called object code elements in order to form an executable code element that can be executed by a computer. A footprint containing metadata of the executable code element may also be generated. A footprint containing metadata of each submodule, or CSECT, within the executable code element may also be generated.

At 916, a hash algorithm is executed to calculate a hash value for the contents of the executable code element. The hash algorithm can also be executed to calculate a hash value for each submodule, or CSECT, within the executable code element. At 918, the hash value of the submodules is stored in the footprints of the respective submodules of the executable code element in the executable library. In one example, each footprint may be stored in an identification record of a respective submodule.

At 920, the hash value of the executable code element is stored in the footprint of the executable code element in the executable library. In one example, footprint may be stored in an identification record of the executable code element and also in a directory of the executable library. It should also be noted that the metadata (or portions thereof) in the footprints of the executable code element and/or the submodules may be compressed using appropriate compression techniques to provide space in the footprint data structure to store the hash value of the execution code element or submodule.

At 922, a master hash file may be updated with the hash values of the executable code element and any submodules, which may be linked, mapped, or otherwise associated to respective identifiers of the executable code element and any submodules. If the identifiers of the executable code element and any submodules are not already stored in master hash file, then they may be added to the master hash file.

With reference again to 912, if one or more of the validation procedures performed on the elements to be linked and/or bound (e.g., main object code element, other object code elements) fail (e.g., if any of the hash value comparisons fails), then the one or more elements of the one or more failed validation procedures are not validated. In this scenario, an exception to the linker/binder process may be raised based on the validation failure. At 924, one or more actions may be performed in response to the raised exception. For example, the exception may be logged in an audit file, a text message alert may be sent to notify appropriate individuals, an error message may be displayed on one or more user terminals coupled to the development system, the linking/binding may be blocked until the validation failure is corrected (e.g., the compromised element(s) is updated with uncompromised contents) and the linking/binding is restarted, or until an authorized user bypasses the block by manually deleting the footprint information for the compromised element. In this case any element without a footprint could be flagged in the footprint exception reports until corrected. Furthermore, any other actions implemented in the system may be taken in addition to or alternative to the previously enumerated actions.

At 926, an exception report (e.g., 127) may be generated to identify the object code element(s) that failed validation and caused the validation failure exception.

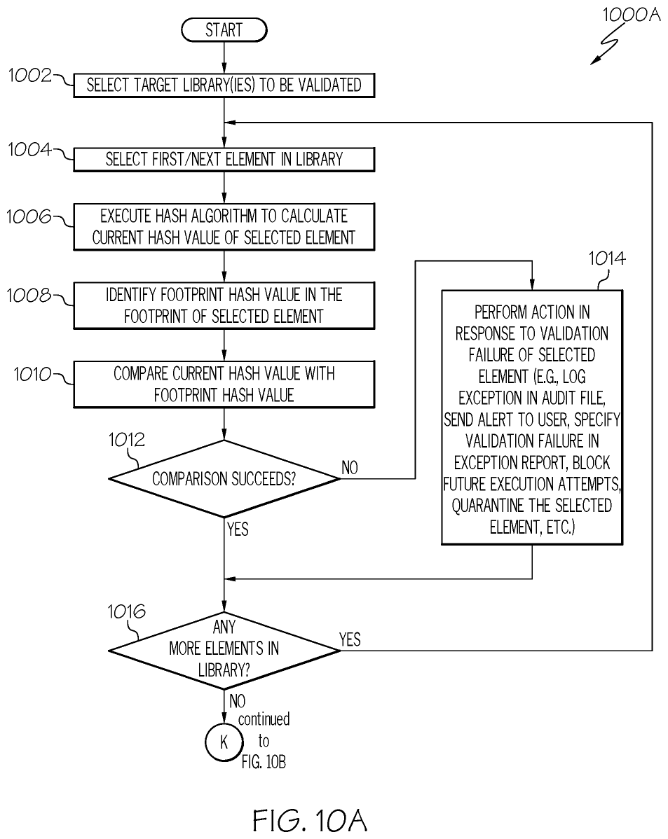

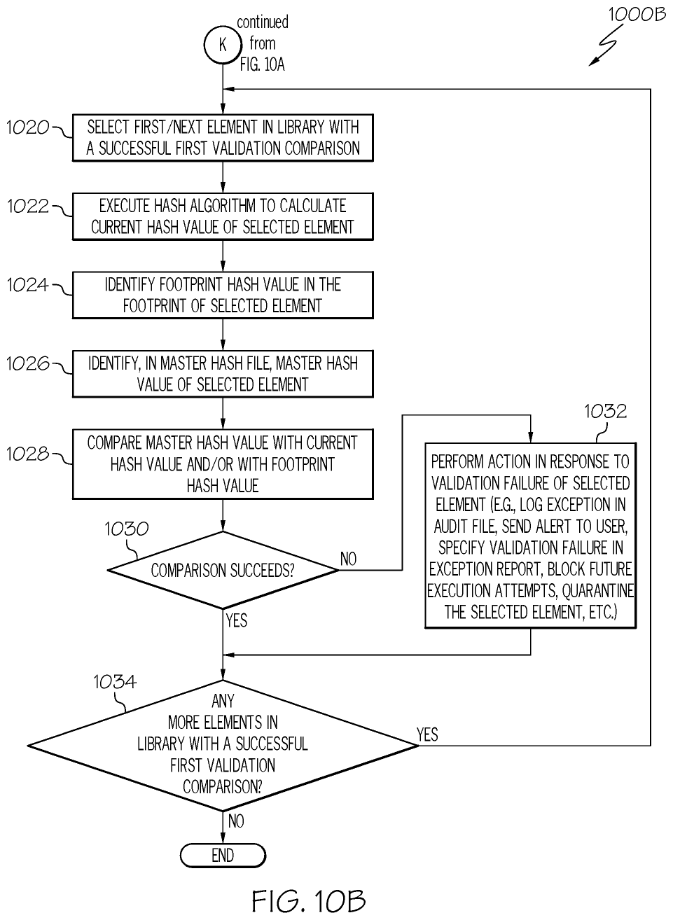

Turning to FIGS. 10A-10B, simplified flowcharts 1000A and 1000B illustrate example techniques involved in performing validation procedures on elements in one or more selected libraries in an on-demand procedure or in a scheduled process. In at least one embodiment, one or more operations correspond to activities of FIGS. 10A and 10B. In one example, a development system (e.g., 120) or a production system (e.g., 170), or a portion thereof, may perform at least some of the one or more operations. The development system or production system may comprise means, such as processor 128, 178 and memory 129, 179, for performing the operations. In an embodiment, one or more operations of flows of FIGS. 10A and 10B may be performed by a footprint exception detector (e.g., 126) in the development system or by a footprint exception detector (e.g., 176) in the production system.

In flowchart 1000A, at 1002, a target library is selected for validation. For example, any library such as source library 130, common library 140, object library 150, non-production executable library 190, or production executable library 180 may be selected for validating its elements. At 1004, a first element in the selected library is selected for validation.

At 1006, a hash algorithm is executed to calculate a current hash value of the selected element. At 1008, a hash value in the footprint of the selected element is identified. At 1010, the current hash value of the selected element and the footprint hash value of the selected element are compared.

At 1012, a determination is made as to whether the first validation comparison was successful. For example, if the hash values match or otherwise correspond (e.g., complementary values, etc.) to each other, then the comparison succeeds. If the hash values do not match or do not otherwise correspond, then the first validation comparison fails and therefore, the validation of the selected element fails.

If the first validation comparison fails and the selected element is not validated, then at 1014, one or more actions may be performed in response to the validation failure of the selected element. For example, the exception may be logged in an audit file, an alert may be generated (e.g., text message sent to notify appropriate individuals), and/or an error message may be displayed on one or more user terminals coupled to the system (e.g., development system or production system) that is coupled to the selected library.

If the invalid element is an executable code element, then other possible actions that could be taken at 1014, include blocking the invalid element from future execution attempts until the validation failure is corrected (e.g., the compromised element(s) is updated with uncompromised contents) or allowing execution of the invalid element as a quarantined program. In at least one embodiment, blocking an invalid element can be achieved by quarantining the invalid element (e.g., by renaming it) and inserting a stub program in its place. The stub program, if called (e.g., in a subsequent ‘read’ execution) could continue to generate the exception message/log events and prevent execution of the invalid element.

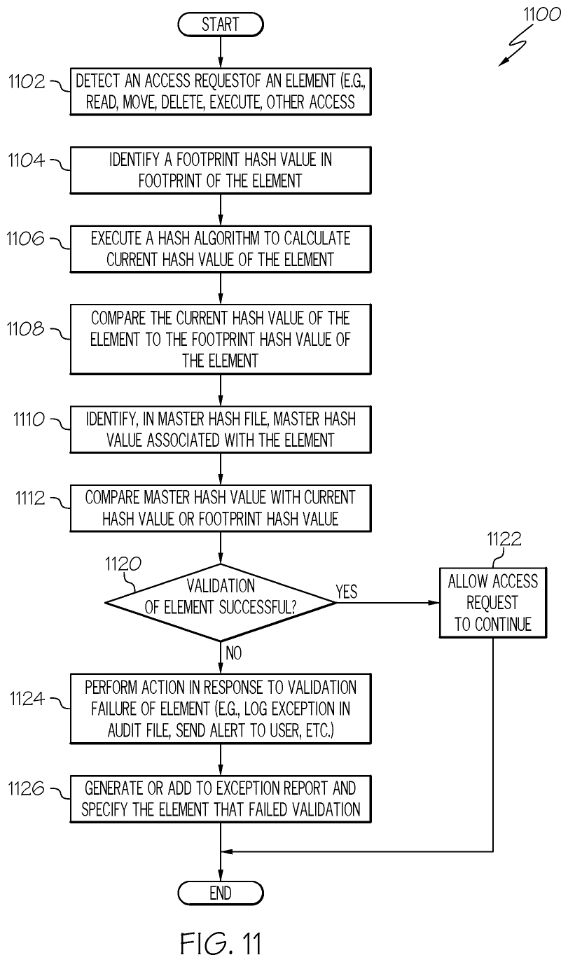

In at least one embodiment, allowing the execution of an invalid element can be achieved by quarantining the invalid element (e.g., by renaming it) and inserting a stub program in its place, where stub program allows execution. For example, based on policy, the stub program could link to (or invoke) the “quarantined element” to continue normal processing. A policy could be implemented to make repeated failures either hard, causing an exception or abnormal end (abend), or soft, generating audit exception messages in the audit file when encountered. In both scenarios (i.e., blocking the invalid element, allowing the execution of the invalid element based on policy) the new stub program itself could have a calculated hash so it can be protected from modification. For example, in at least one embodiment, a second validation of the selected library or a validation of the element in real-time (e.g., FIG. 11) would find and validate the stub program and the quarantined element. Thus, the stub program could bypass the exception auditing and directly call the quarantined element. If the stub is compromised (e.g., causing it to link to malicious code, etc.), then an exception would be raised and recorded in an audit file.

If the first validation comparison succeeds at 1012, then at 1016, a determination is made as to whether more elements are stored in the selected library. If more elements are stored in the selected library, then flow may pass back to 1004 to select the next element in the selected library. The processing may continue for each element in the selected library until at 1016, it is determined that there are no more elements in the selected library to be processed. Once the first validation comparison is performed on the current hash values and footprint hash values of the elements in the selected library, a second validation comparison may be performed on the elements that were successfully validated in the first validation comparison.

At 1020, the first element in the selected library that had a successful first validation comparison (at 1012), may be selected. At 1022, a hash algorithm to calculate the current hash value of the selected element may be performed. In other embodiments, the current hash values of the elements in the selected library that are calculated at 1006 may be stored during the first validation comparisons and accessed as needed for the second validation comparisons to avoid recalculating the hash values.

At 1024, the hash value in the footprint of the selected element is identified. At 1026, a master hash file can be searched for hash values associated with the element. In at least one embodiment, at least a portion of the metadata from the footprint of the selected element can be used to search element identifiers, which are associated to hash values, in the master hash file. If the element identifier corresponding to the selected element is located, then the hash value from the master hash file corresponding to the element can be identified.

At 1028, the master hash value of the selected element is compared to the current hash value of the selected element and/or to the footprint hash value of the selected element. Either the current hash value or the footprint hash value may be used since the first validation comparison, at 1010 and 1012, indicated that that these hash values matched, or otherwise corresponded.

At 1030, a determination can be made as to whether the second validation comparison is successful. If the hash values match or otherwise correspond, then the second validation comparison succeeds. However, if the hash values do not match or do not otherwise correspond, then the second validation comparison fails and therefore, the validation of the selected element fails.

If the second validation comparison fails and the selected element is not validated, then at 1032, one or more actions may be performed in response to the validation failure of the selected element. The one or more actions that may be performed at 1032, can include any of the actions previously described herein at 1014, with reference to the first validation comparison failure.

If the second validation comparison succeeds at 1030, then the selected element is validated and at 1034, a determination is as to whether there are any more elements stored in the selected library that had a successful first validation comparison (at 1012). If more elements that had successful first validation comparisons are stored in the selected library, then flow may pass back to 1020 to select the next element in the selected library that had a successful first validation comparison. The processing may continue for each element that is selected until at 1034, it is determined that there are no more elements in the selected library to be processed. Once the second validation comparisons have been performed, the validation procedure for each element in the selected library is completed and the flow may end.

Turning to FIG. 11, a simplified flowchart 1100 illustrates example techniques involved in performing a validation procedure on an element based on a detected access request (e.g., read request, execution request, etc.) of the element. In at least one embodiment, one or more operations correspond to activities of FIG. 11. In one example, a development system (e.g., 120) or a production system (e.g., 170), or a portion thereof, may perform at least some of the one or more operations. The development system or production system may comprise means, such as processor 128, 178 and memory 129, 179, for performing the operations. In an embodiment, one or more operations of flow 1100 may be performed by a footprint exception detector (e.g., 126) in the development system or by a footprint exception detector (e.g., 176) in the production system.

At 1102, an access request for an element is detected. An access request can include, but is not limited to, a request to read, move, delete, execute the element. For example, an access request may be detected when an element is being moved to another device, such as deploying an executable code element from a development system (e.g., 120) to a production system (e.g., 170). In another example, a read request may be detected when an executable code element is invoked for execution (e.g., for a production execution by production system 170, for testing on development system 120, etc.). In yet another example, if an implementation replaces invalid executable code elements with stub elements, then for a stub element that links to a quarantined program, the access request may be a request for quarantined access.

At 1104, a hash value in a footprint of the element is identified. At 1106, a hash algorithm is executed to calculate a current hash value of the contents of the element. At 1108, the current hash value of the element is compared to the footprint hash value of the element.

At 1110, a master hash file can be searched for a hash value associated with the element. In at least one embodiment, metadata from the footprint of the element can be used to search element identifiers in the master hash file. If an element identifier is located based on the metadata from the footprint, then the hash value from the master hash file corresponding to the element can be identified.

At 1112, the master hash value of the element is compared to the current hash value of the element or the footprint hash value of the element. In some implementations, the comparison against a hash value in the master hash file of an object code element may not be performed if the comparison between a footprint hash value and a calculated hash value of the object code element fails, since this prior failed comparison indicates that the validation procedure failed, and the element is compromised.

At 1120, a determination can be made as to whether the validation procedure was successful for the element. In particular, if one of the hash value comparison fails, then the validation procedure fails, the element is not validated, and an exception for the process requesting access to the element may be raised based on the validation failure.

If the validation procedure is successful (e.g., if the comparisons were successful), then the element is validated and at 1122, the access request may be allowed to proceed. For implementations that replace invalid elements with stub elements that invoke quarantined programs, the quarantined program may have limited access (e.g., print access, read access, etc.).

If the validation procedure fails as determined at 1120, however, then the element is not validated and at 1124, an appropriate action may be taken. In one example, the action may be determined based on a development stage (e.g., creation, testing, QA, production, etc.) of the element. Examples of actions that may be taken include, but are not necessarily limited to, blocking the access request to the element until the validation failure is corrected or until an authorized user overrides the block, logging the exception in an audit file, sending a text message alert to notify appropriate individuals, displaying an error message on one or more user terminals coupled to the system that is coupled to the selected library (e.g., development system or production system). Any other actions implemented in the system may be taken in addition to or alternative to the previously enumerated actions.

At 1126, a footprint exception report may be generated and may identify which element failed validation and which validation comparison failed. For example, the report may indicate whether the first validation comparison failed (e.g., comparison between the footprint has value and the current hash value of the element) or whether the second validation comparison failed (e.g., comparison between a master hash value and either the footprint hash value or the current value of the element. Flow may end once appropriate action is taken based on the result of the validation procedure.

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that all variations of the terms “comprise,” “include,” and “contain,” when used in this specification, specify the presence of stated features, integers, steps, operations, elements, and/or components, but do not preclude the presence or addition of one or more other features, integers, steps, operations, elements, components, and/or groups thereof.

As used herein, unless expressly stated to the contrary, use of the phrase ‘at least one of’ or ‘one or more of’ refers to any combination of the named elements, conditions, or activities. For example, ‘at least one of X, Y, and Z’ is intended to mean any of the following: 1) at least one X, but not Y and not Z; 2) at least one Y, but not X and not Z; 3) at least one Z, but not X and not Y; 4) at least one X and at least one Y, but not Z; 5) at least one X and at least one Z, but not Y; 6) at least one Y and at least one Z, but not X; or 7) at least one X, at least one Y, and at least one Z. Also, unless expressly stated to the contrary, the terms ‘first’, ‘second’, ‘third’, etc., are intended to distinguish the particular noun (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements, that are not necessarily limited by any order, rank, importance, temporal sequence, or hierarchy of the two elements.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
performing a first validation procedure on an element, the first validation procedure including:
identifying a first hash value in a footprint of the element in a storage library;
calculating a second hash value of the element in the storage library;
performing a first validation comparison of the first hash value and the second hash value;
identifying, in a master file, a third hash value associated with the element in the storage library;
performing a second validation comparison of the third hash value identified in the master file and one of the first hash value or the second hash value; and
determining that the element is validated based on determining that the first validation comparison succeeds and that the second validation comparison succeeds.

2. The method of claim 1, further comprising:
prior to performing the first validation procedure, calculating the first hash value by using a hash algorithm on the element in response to generating the element; and
storing the first hash value in the footprint of the element in the storage library and in the master file.

3. The method of claim 1, wherein the first validation comparison is determined to succeed based on the second hash value of the element corresponding to the first hash value identified in the footprint of the element.

4. The method of claim 1, wherein the second validation comparison is determined to succeed based on one of:
the third hash value identified in the master file corresponding to the second hash value of the element; or
the third hash value identified in the master file corresponding to the first hash value identified in the footprint of the element.

5. The method of claim 1, wherein the element is an executable code element generated at least in part from an object code element stored in a second storage library.

6. The method of claim 5, further comprising, prior to generating the executable code element:
performing a second validation procedure on the object code element, including:
identifying a fourth hash value in a footprint of the object code element;
calculating a fifth hash value of the object code element;
performing a third validation comparison of the fourth hash value identified in the footprint of the object code element and the fifth hash value of the object code element;
identifying, in the master file, a sixth hash value associated with the object code element;
performing a fourth validation comparison of the sixth hash value identified in the master file and one of the fourth hash value or the fifth hash value; and
determining that the object code element is validated based on determining that the third validation comparison succeeds and the fourth validation comparison succeeds.

7. The method claim 6, wherein the executable code element is generated based on validating the object code element and validating one or more other object code elements in one or more other validation procedures, respectively.

8. The method of claim 5, wherein the object code element is generated at least in part from a source code element stored in a third storage library.

9. The method of claim 8, further comprising, prior to generating the object code element:
performing a third validation procedure on the source code element, including:
identifying a seventh hash value in a footprint of the source code element;
calculating an eighth hash value of the source code element; and
performing a fifth validation comparison of the seventh hash value and the eighth hash value;
identifying, in the master file, a ninth hash value associated with the source code element;
performing a sixth validation comparison of the ninth hash value identified in the master file and one of the seventh hash value or the eighth hash value; and
determining that the source code element is validated based on determining that the fifth validation comparison succeeds and that the sixth validation comparison succeeds.

10. The method of claim 1, wherein the first validation procedure is performed in response to detecting an access request of the element in the storage library.

11. The method of claim 1, wherein the element is a source code element, and wherein the first validation procedure is performed in response to detecting an execution of a program to compile or assemble the element.

12. A non-transitory computer readable medium comprising program code that is executable by a computer system to perform operations comprising:
performing a first validation procedure on an element, the first validation procedure to include:
identifying a first hash value in a footprint of the element in a storage library;
calculating a second hash value of the element in the storage library;
performing a first validation comparison of the first hash value and the second hash value;
identifying, in a master file, a third hash value associated with the element in the storage library;
performing a second validation comparison of the third hash value identified in the master file and one of the first hash value or the second hash value; and
determining that the element is not validated based on determining that the first validation comparison fails or the second validation comparison fails.

13. The non-transitory computer readable medium of claim 12, wherein the program code is executable by the computer system to perform further operations comprising:
prior to performing the first validation procedure, calculating the first hash value by using a hash algorithm on the element in response to updating the element; and
storing the first hash value in the footprint of the element in the storage library and in the master file.

14. The non-transitory computer readable medium of claim 12, wherein the first validation comparison is determined to fail based on the second hash value of the element not corresponding to the first hash value identified in the footprint of the element.

15. The non-transitory computer readable medium of claim 12, wherein the second validation comparison is determined to fail based on one of:
the third hash value identified in the master file not corresponding to the second hash value of the element; or
the third hash value identified in the master file not corresponding to the first hash value identified in the footprint of the element.

16. The non-transitory computer readable medium of claim 12,
wherein the first validation procedure is performed in response to detecting an access request of the element in the storage library, and
wherein the element is one of a source code element, a common code element, an object code element, or an executable code element.

17. An apparatus comprising:
a memory including instructions stored therein;
a storage library for storing an object code element and a footprint of the object code element; and
a processor, wherein the instructions are executable by the processor to:
identify the object code element in the storage library to be used to generate an executable code element; and
perform a first validation procedure on the object code element, the first validation procedure to include:
identifying a first hash value in the footprint of the object code element;
calculating a second hash value of the object code element;
performing a first comparison of the first hash value and the second hash value;
performing a second comparison of a third hash value from a master file and one of the first hash value or the second hash value; and
generate the executable code element from the object code element based, at least in part, on determining that the first comparison succeeds and the second comparison succeeds.

18. The apparatus of claim 17, wherein the first comparison is determined to succeed based on the second hash value of the object code element corresponding to the first hash value identified in the footprint of the object code element.

19. The apparatus of claim 17, wherein the instructions are executable by the processor to further:
calculate a fourth hash value of the executable code element; and
store the fourth hash value in a footprint of the executable code element in a second storage library.

20. The apparatus of claim 19, wherein the instructions are executable by the processor to further:
compress metadata associated with the executable code element; and
generate the footprint of the executable code element, wherein the footprint includes the compressed metadata and the fourth hash value.
